(19) United States
(12) Patent Application Publication
(10) Pub. No.: US 2024/0219963 A1
(43) Pub. Date: Jul. 4, 2024

(54) FOLDABLE ELECTRONIC DEVICE

(71) Applicant: Quanta Computer Inc., Taoyuan City (TW)

(72) Inventors: Wen-Hung TSAI, Taoyuan City (TW); Gwo-Chyuan CHEN, Taoyuan City (TW); Chang-Ta MIAO, Taoyuan City (TW); Chu-Fu WANG, Taoyuan City (TW); Shun Kai CHUANG, Taoyuan City (TW)

(21) Appl. No.: 18/312,008

(22) Filed: May 4, 2023

(30) Foreign Application Priority Data
Jan. 4, 2023 (TW) 112200040

(51) Int. Cl. G06F 1/16

(52) U.S. Cl. CPC G06F 1/1641; G06F 1/1681

(57) ABSTRACT

A foldable electronic device is provided, including a first display, a second display, an input unit, a first hinge, a second hinge, and a flat support unit. The first hinge pivotally connects the first display to the second display. The second hinge pivotally connects the second display to the input unit. The first and second hinges are located on opposite sides of the second display, and the support unit is pivotally connected to the rear side of the second display.

### CROSS REFERENCE TO RELATED APPLICATIONS

This application claims priority of Taiwan Patent Application No. 112200040, filed on Jan. 4, 2023, the entirety of which is incorporated by reference herein.

### BACKGROUND OF THE INVENTION

### Field of the Invention

The present invention relates to a foldable electronic device, and, in particular, to a foldable electronic device that can be used either as a laptop computer or a tablet computer.

### Description of the Related Art

Conventional laptop computers typically have one screen, and it would be inconvenient for two different users when watching the screen at the same time. Moreover, since the screen of conventional laptop computers usually cannot rotate in a wide range, the viewing angle for users is limited, and the laptop computers also cannot be used as tablet computers.

Therefore, to design a foldable electronic device that can be used either as laptop computer or tablet computer becomes a challenge.

### BRIEF SUMMARY OF THE INVENTION

An embodiment of the present invention provides a foldable electronic device that includes a first display unit, a second display unit, an input unit, a first hinge, a second hinge, and a support unit. The first hinge is pivotally connecting the first display unit to the second display unit. The second hinge is pivotally connecting the second display unit to the input unit, wherein the first and second hinges are located on opposite sides of the second display unit. The support unit has a flat structure that is pivotally connected to the rear side of the second display unit.

In some embodiments, the first display unit has a first screen, and the second display unit has a second screen facing the first screen when the foldable electronic device is in a closed mode.

In some embodiments, when the foldable electronic device is in the closed mode, the first display unit is located between the second display unit and the input unit.

In some embodiments, when the foldable electronic device is in the closed mode, the user input interface of the input unit faces the first display unit.

In some embodiments, when the foldable electronic device is in a dual screen mode, the first and second screens face the same direction, and the support unit is angled relative to the second display unit for supporting the first and second display units.

In some embodiments, when the foldable electronic device is in a tent mode, the first and second display units form an inverted-V structure.

In some embodiments, when the foldable electronic device is in a laptop mode, the first and second screens face opposite directions, and a tilt angle is formed between the second screen and the input unit.

In some embodiments, when the foldable electronic device is in a tablet mode, the first and second screens face opposite directions, and a user input interface of the input unit faces the second display unit.

In some embodiments, when the foldable electronic device is in the tablet mode, the second display unit is located between the first display unit and the input unit.

In some embodiments, the input unit comprises a keyboard or a touchpad.

### BRIEF DESCRIPTION OF THE DRAWINGS

The present invention can be more fully understood by reading the subsequent detailed description and examples with references made to the accompanying drawings, wherein:

FIG. 1 is a front view of a foldable electronic device 100 when expanded, in accordance with an embodiment of the invention.

FIG. 2 is a rear view of the foldable electronic device 100 in FIG. 1.

FIG. 3 is side view of the foldable electronic device 100 in FIGS. 1 and 2, wherein the second hinge H23 rotates 90 degrees relative to the first display unit 10, the second display unit 20, the input unit 30, and the support unit 40.

FIG. 4 is a perspective diagram of the foldable electronic device 100 when in a closed mode.

FIG. 5 is a perspective diagram showing the first and second display units 10 and 20 when unfolded relative to the input unit 30 from the state of FIG. 4.

FIG. 6 is a perspective diagram showing the first display unit 10 when unfolded relative to second display unit 20 from the state of FIG. 5.

FIG. 7 is a perspective diagram showing the support unit 40 unfolded relative to second display unit 20 for supporting the first and second display units 10 and 20.

FIG. 8 is a perspective diagram showing the first and second display units 10 and 20 and the support unit 40 rotating relative to the input unit 30.

FIG. 9 is a perspective diagram showing the support unit 40 when folded to the rear side of the second display unit 20.

FIG. 10 is a perspective diagram showing the first display unit 10 when flipped over to the rear side of the second display unit 20 from the state of FIG. 9.

FIG. 11 is a perspective diagram showing the first display unit 10 when flipped over and folded to the rear side of the second display unit 20 from the state of FIG. 10.

FIG. 12 is a perspective diagram showing the first and second display units 10 and 20 when rotating toward the input unit 30 via the second hinge H23.

FIG. 13 is a perspective diagram showing the first and second display units 10 and 20 folded to the input unit 30 from the state of FIG. 12.

### DETAILED DESCRIPTION OF THE INVENTION

The making and using of the embodiments of the foldable electronic device are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

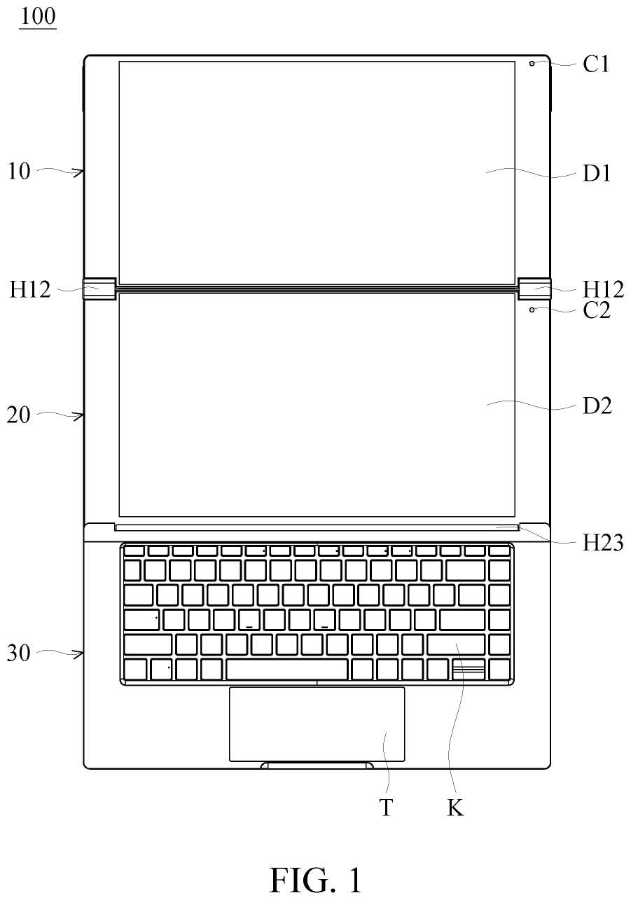

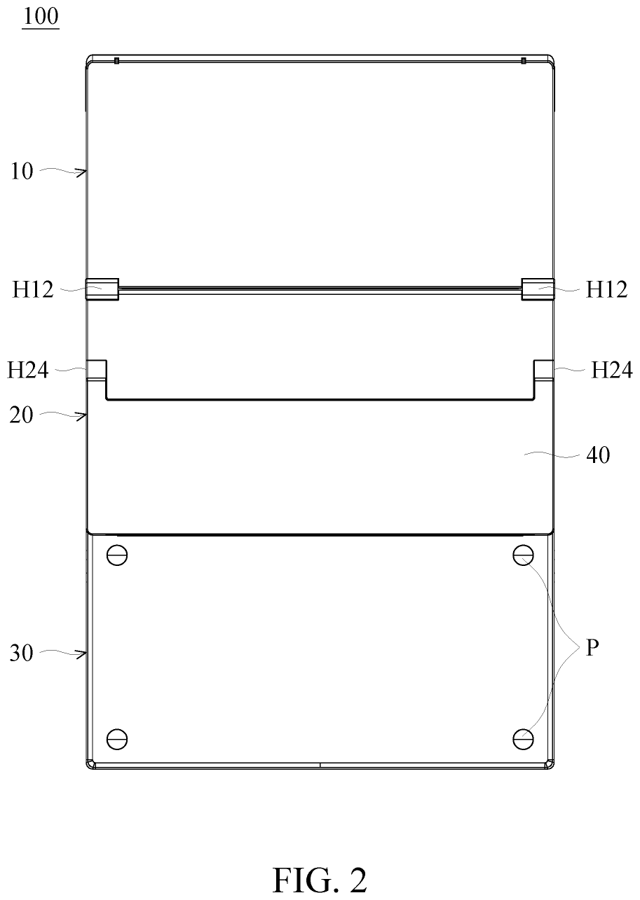

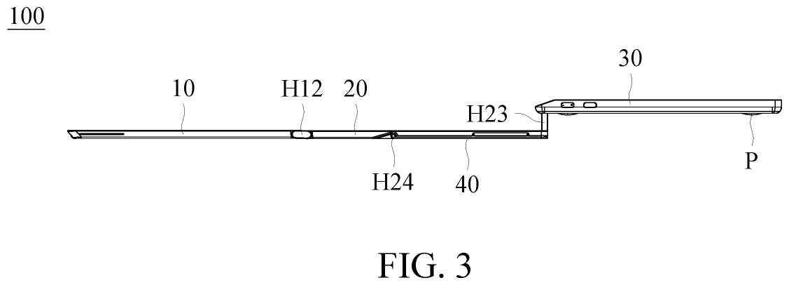

FIG. 1 is a front view of a foldable electronic device 100 when expanded, in accordance with an embodiment of the invention. FIG. 2 is a rear view of the foldable electronic device 100 in FIG. 1. FIG. 3 is side view of the foldable electronic device 100 in FIGS. 1 and 2, wherein the second hinge H23 rotates 90 degrees relative to the first display unit 10, the second display unit 20, the input unit 30, and the support unit 40.

Referring to FIGS. 1-3, the foldable electronic device 100 may be a laptop computer that primarily comprises a first display unit 10, a second display unit 20, a input unit 30, and a flat support unit 40. The first display unit 10 and the second display unit 20 are pivotally connected to each other via a first hinge H12. The second display unit 20 and the input unit 30 are pivotally connected to each other via a second hinge H23. The support unit 40 is pivotally connected to the rear side of the second display unit 20 via the hinge H24.

It should be noted that the first and second hinges H12 and H23 are locate on opposite sides of the second display unit 20. The first display unit 10 is capable of 360-degree rotation around the second display unit 20 via the first hinge H12, and the second display unit 20 is capable of 360-degree rotation around the input unit 30 via the second hinge H23.

In this embodiment, the second hinge H23 comprises a drop hinge, but not limited to the embodiments disclosed in the invention.

The first display unit 10 has a first screen D1, and the second display unit 20 has a second screen D2. The second screen D2 and the support unit 40 are located on opposite sides of the second display unit 20. In some embodiments, the second screen D2 may be LCD, OLED or touch screen, but not limited to the embodiments disclosed in the invention.

As shown in FIG. 1, the first display unit 10 further has a first camera C1, and the second display unit 20 further has a second camera C2. The first camera C1 and the first screen D1 are disposed on the same side of the first display unit 10, and the second camera C2 and the second screen D2 are disposed on the same side of the second display unit 20. Photographing, video recording, video conference, and live streaming can be achieved by using the first and second cameras C1 and C2.

Moreover, a keyboard K (e.g. qwerty keyboard) and a touchpad T are disposed on the front side of the input unit 30 as a user input interface when using the electronic device 100. The first and second display units 10 and 20 can be unfolded relative to the input unit 30, and the user can input instructions and/or move the cursor on the first and second screens D1 and D2 via the keyboard K and/or the touchpad T.

It can be seen in FIGS. 2 and 3 that several foot pads P are disposed on the bottom side of the input unit 30. The foot pads P can contact the table for supporting the foldable electronic device 100. When the foldable electronic device 100 is placed on the table, a gap is formed between the input unit 30 and the table for heat dissipation, thereby preventing overheating of the foldable electronic device 100.

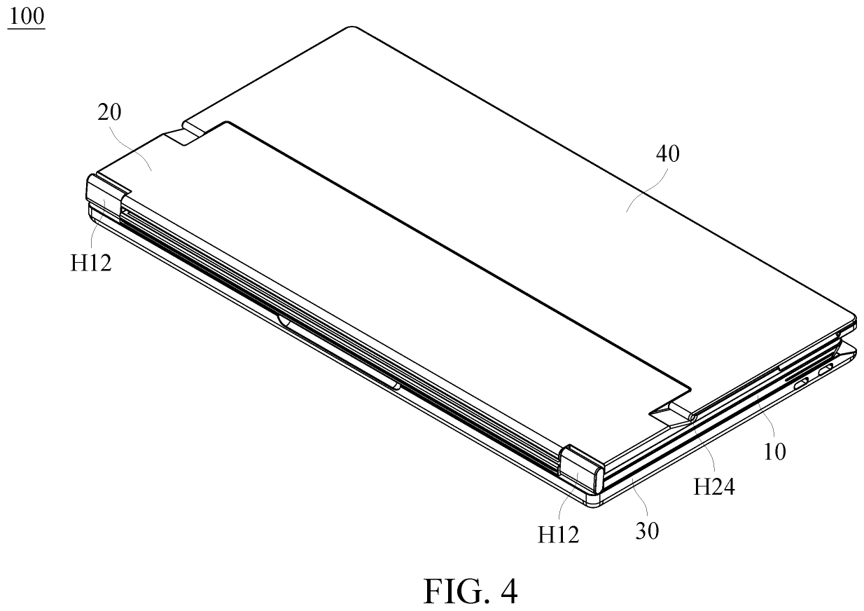

FIG. 4 is a perspective diagram of the foldable electronic device 100 when in a closed mode.

Referring to FIG. 4, when the foldable electronic device 100 is in a closed mode, the first and second screens D1 and D2 of the first and second display units 10 and 20 face each other and are not exposed to the outside of the foldable electronic device 100. In this state the keyboard K and the touchpad T of the input unit 30 face the first display unit 10, wherein the first display unit 10 is located between the second display unit 20 and the input unit 30.

Moreover, as shown in FIG. 4, when the foldable electronic device 100 is in the closed mode, the support unit 40 is attached to the rear side of the second display unit 20, wherein the first and second display units 10 and 20, the input unit 30, and the support unit 40 are substantially parallel to each other.

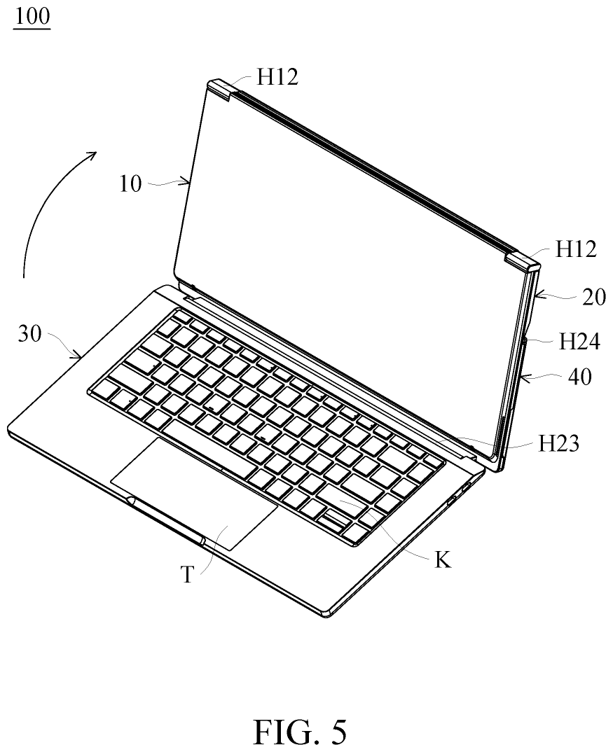

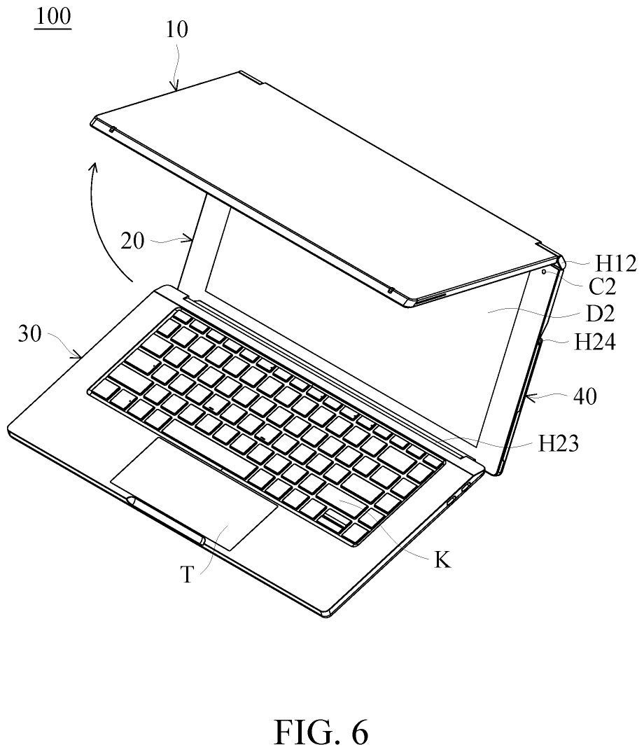

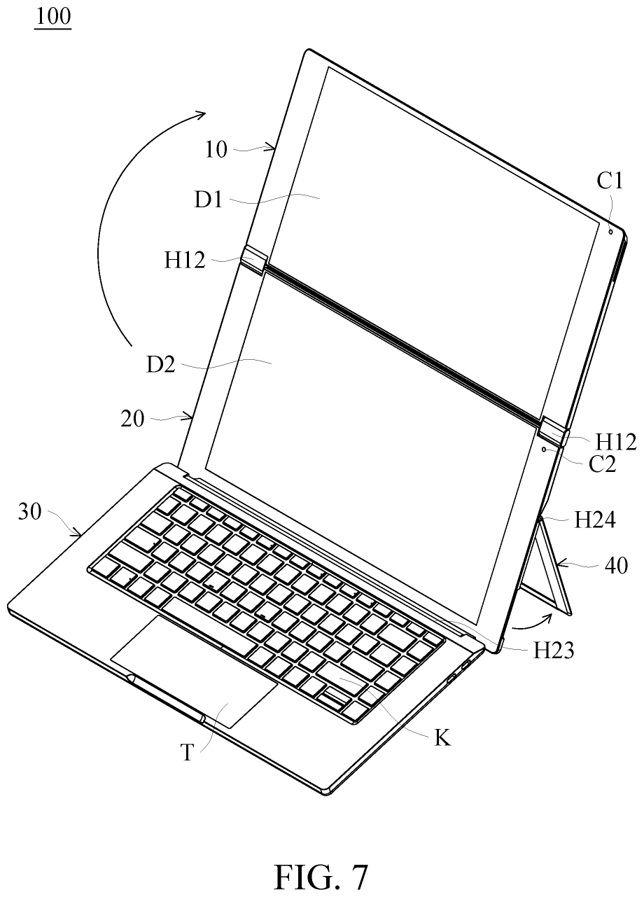

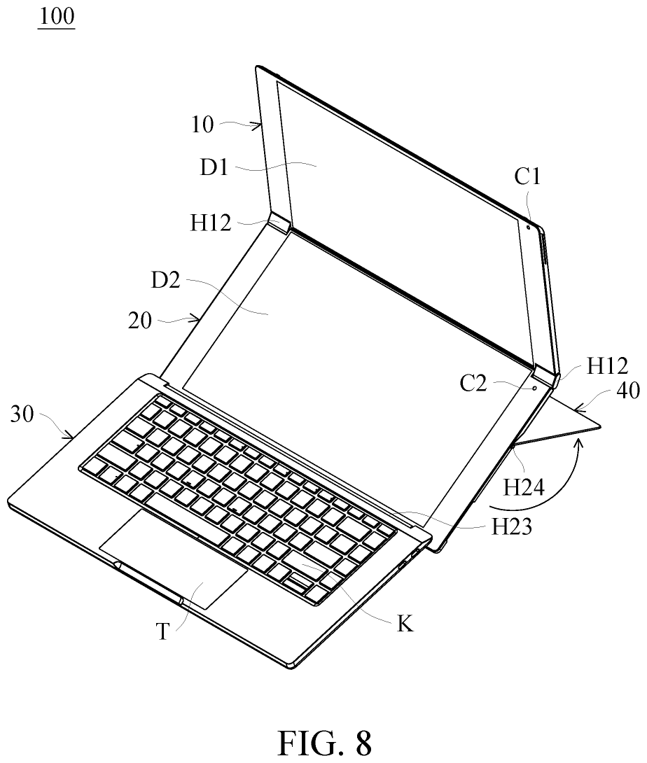

FIG. 5 is a perspective diagram showing the first and second display units 10 and 20 when unfolded relative to the input unit 30 from the state of FIG. 4. FIG. 6 is a perspective diagram showing the first display unit 10 when unfolded relative to second display unit 20 from the state of FIG. 5. FIG. 7 is a perspective diagram showing the support unit 40 unfolded relative to second display unit 20 for supporting the first and second display units 10 and 20. FIG. 8 is a perspective diagram showing the first and second display units 10 and 20 and the support unit 40 rotating relative to the input unit 30.

Referring to FIG. 5, when using the foldable electronic device 100, the first and second display units 10 and 20 can be unfolded relative to the input unit 30 so that the first display unit 10 is exposed to the outside of the foldable electronic device 100. Subsequently, as shown in FIG. 6, the first display unit 10 can be rotated relative to the second display unit 20 from the state of FIG. 5 to expose the first and second screens D1 and D2.

After adjusting the first and second display units 10 and 20 to an appropriate angle, the support unit 40 can be unfolded outwardly relative to second display unit 20 for supporting the first and second display units 10 and 20, thus facilitating structural stability of the foldable electronic device 100 during usage.

It should be noted that when the first and second display units 10 and 20 are unfolded relative to the input unit 30, as the state shown in FIG. 7, the first and second screens D1 and D2 face the same direction, and the foldable electronic device 100 is switched to a dual screen mode for a better viewing experience.

When the foldable electronic device 100 is in the dual screen mode, the user can further rotate the support unit 40 and the first and second display units 10 and 20 relative to the input unit 30, as the arrow shows in FIG. 8, whereby the foldable electronic device 100 is switched to a tilt mode to meet each user's need. Therefore, comfortable and convenient use of the foldable electronic device 100 is achieved.

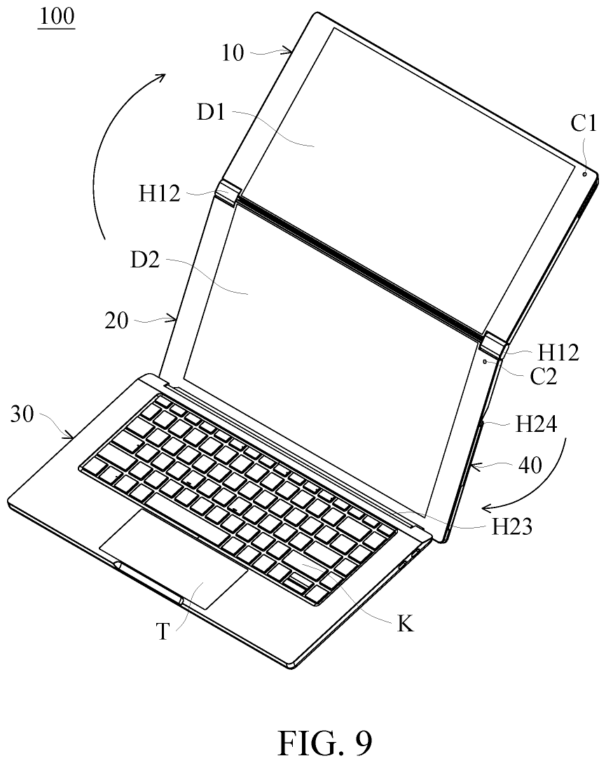

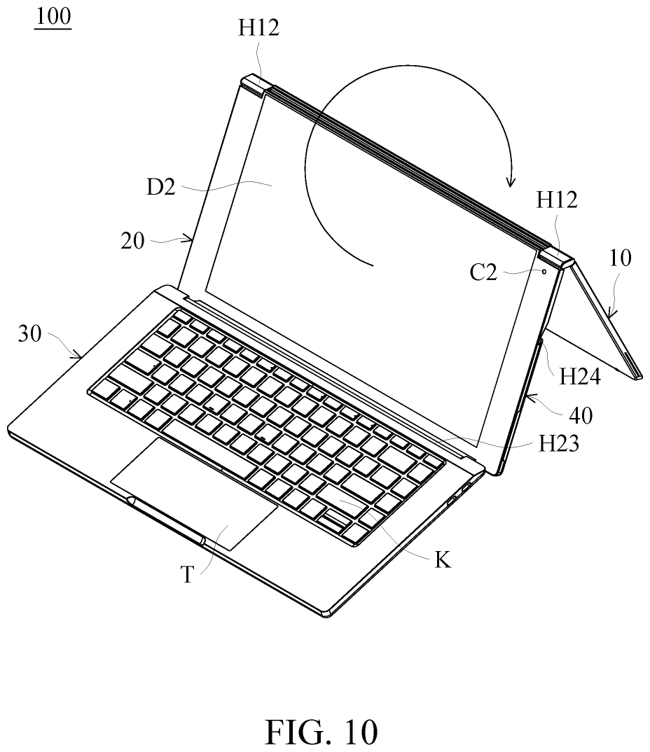

FIG. 9 is a perspective diagram showing the support unit 40 when folded to the rear side of the second display unit 20. FIG. 10 is a perspective diagram showing the first display unit 10 when flipped over to the rear side of the second display unit 20 from the state of FIG. 9.

Referring to FIG. 9, to switch the foldable electronic device 100 to a tent mode, the support unit 40 can be folded to the rear side of the second display unit 20. Subsequently, the first display unit 10 can be flipped over to the rear side of the second display unit 20 from the state of FIG. 9 to the state shown in FIG. 10. In this state, the first and second display units 10 and 20 form an inverted-V structure that can stand on the table like a tent.

When the foldable electronic device 100 is in the tent mode, the first and second screens D1 and D2 face opposite sides of the foldable electronic device 100. In this state, two users can see the first and second screens D1 and D2 from opposite sides, and they can make a face to face discussion about the presentation slides or documents on the first and second screens D1 and D2.

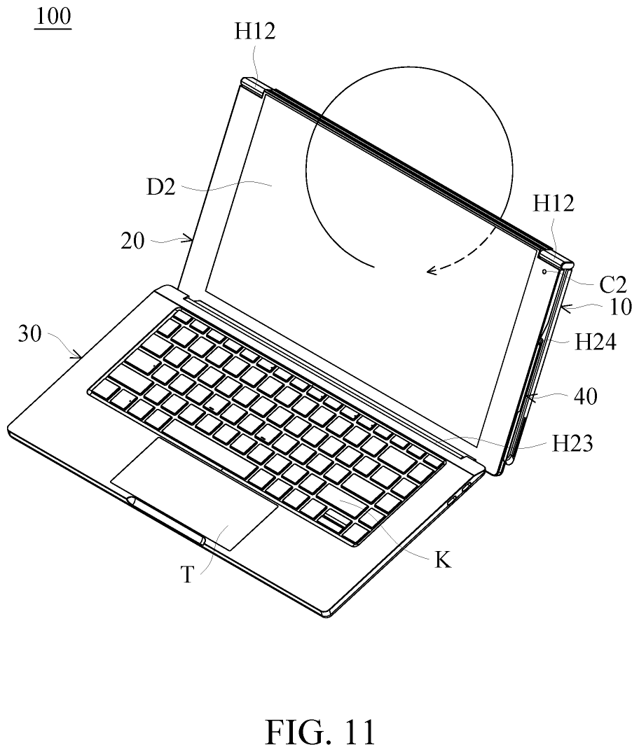

FIG. 11 is a perspective diagram showing the first display unit 10 when flipped over and folded to the rear side of the second display unit 20 from the state of FIG. 10.

Referring to FIG. 11, to use the foldable electronic device 100 as a laptop computer, the first display unit 10 can be further flipped over and folded to the rear side of the second display unit 20 from the state of FIG. 10. In this state, the foldable electronic device 100 is switched to a laptop mode, wherein the first and second display units 10 and 20 are folded back to back, and the first and second screens D1 and D2 face opposite directions.

When in the laptop mode, a tilt angle is formed between the second screen D2 and the input unit 30. Hence, the user can easily input instructions and/or move the cursor on the second screen D2, and the first screen D1 can be shut off for power saving and meeting the user's habit when using the laptop computer.

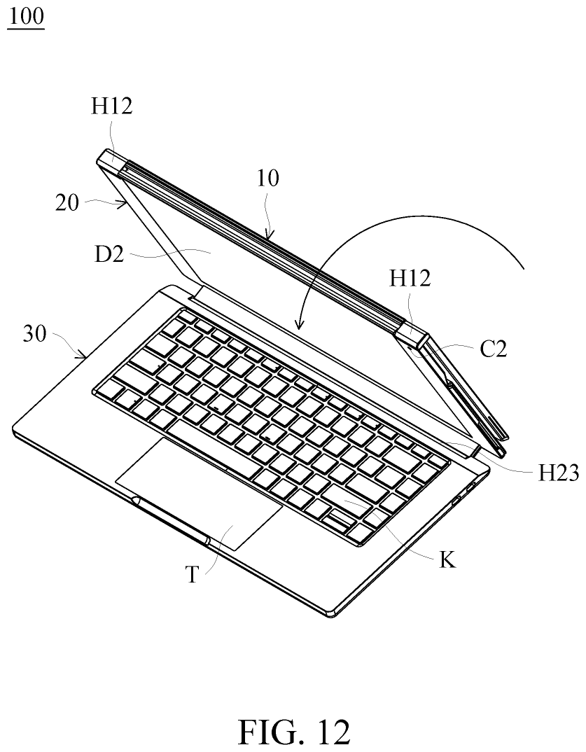

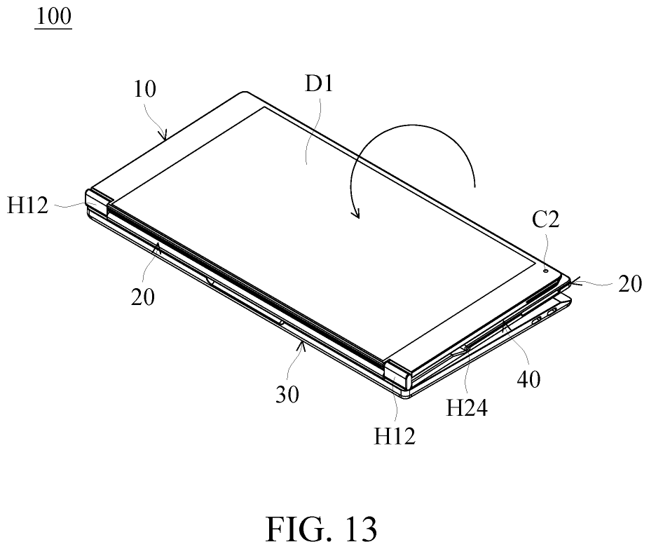

FIG. 12 is a perspective diagram showing the first and second display units 10 and 20 when rotating toward the input unit 30 via the second hinge H23. FIG. 13 is a perspective diagram showing the first and second display units 10 and 20 folded to the input unit 30 from the state of FIG. 12.

Referring to FIG. 12, when switching the foldable electronic device 100 to a tablet mode, the first and second display units 10 and 20 can be rotated toward the input unit 30 via the second hinge H23. Subsequently, the first and second display units 10 and 20 can be folded to the input unit 30 as the state shown in FIG. 13.

It should be noted that when the foldable electronic device 100 is in the tablet mode, the first and second screens D1 and D2 face opposite directions. Specifically, the keyboard K and the touchpad T on the input unit 30 face the second display unit 20, and the first camera C1 and the first screen D1 are exposed to the outside of the foldable electronic device 100, wherein the second display unit 20 is located between the first display unit 10 and the input unit 30. Hence, the user can operate the foldable electronic device 100 as a tablet computer through the first screen D1 (e.g. touch screen).

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A foldable electronic device, comprising:
a first display unit;
a second display unit;
an input unit;
a first hinge, pivotally connecting the first display unit to the second display unit;
a second hinge, pivotally connecting the second display unit to the input unit, wherein the first and second hinges are located on opposite sides of the second display unit; and
a support unit, having a flat structure and pivotally connected to a rear side of the second display unit.

2. The foldable electronic device as claimed in claim 1, wherein the first display unit has a first screen, and the second display unit has a second screen facing the first screen when the foldable electronic device is in a closed mode.

3. The foldable electronic device as claimed in claim 2, wherein when the foldable electronic device is in the closed mode, the first display unit is located between the second display unit and the input unit.

4. The foldable electronic device as claimed in claim 2, wherein when the foldable electronic device is in the closed mode, a user input interface of the input unit faces the first display unit.

5. The foldable electronic device as claimed in claim 2, wherein when the foldable electronic device is in a dual screen mode, the first and second screens face the same direction, and the support unit is angled relative to the second display unit for supporting the first and second display units.

6. The foldable electronic device as claimed in claim 2, wherein when the foldable electronic device is in a tent mode, the first and second display units form an inverted-V structure.

7. The foldable electronic device as claimed in claim 2, wherein when the foldable electronic device is in a laptop mode, the first and second screens face opposite directions, and a tilt angle is formed between the second screen and the input unit.

8. The foldable electronic device as claimed in claim 2, wherein when the foldable electronic device is in a tablet mode, the first and second screens face opposite directions, and a user input interface of the input unit faces the second display unit.

9. The foldable electronic device as claimed in claim 8, wherein when the foldable electronic device is in the tablet mode, the second display unit is located between the first display unit and the input unit.

10. The foldable electronic device as claimed in claim 1, wherein the input unit comprises a keyboard or a touchpad.
